(19) United States
(12) Patent Application Publication
(10) Pub. No.: US 2022/0097153 A1
(43) Pub. Date: Mar. 31, 2022

(54) Saw Blade

(71) Applicant: Robert Bosch GmbH, Stuttgart (DE)

(72) Inventor: Samuel Jaccard, Buchs (CH)

(21) Appl. No.: 17/481,993

(22) Filed: Sep. 22, 2021

(30) Foreign Application Priority Data
Sep. 28, 2020 (DE) 10 2020 212 137.0

(51) Int. Cl. B23D 51/10; B23D 61/12

(52) U.S. Cl. CPC B23D 51/10; B23D 61/128; B23D 61/123

(57) ABSTRACT

A saw blade for a hand-operated machine tool, in particular a reciprocating saw blade, includes a blade portion having a cutting edge and an opposite blade rear, in particular a cutting edge which is defined by a large number of saw teeth. The saw blade further includes a chucking shaft provided to be received by a clamping chuck of the hand-operated machine tool and a lower edge and an opposite upper edge. A transition region is constructed between the chucking shaft and the blade portion, in which a difference in spacing between the spacing of the lower edge and upper edge of the chucking shaft and the spacing between the cutting edge and the blade rear is bridged. A transition region lower edge has a raised portion, in particular a raised portion for stress relief, between the lower edge of the chucking shaft and the cutting edge.

This application claims priority under 35 U.S.C. § 119 to application no. DE 10 2020 212 137.0, filed on Sep. 28, 2020 in Germany, the disclosure of which is incorporated herein by reference in its entirety.

The disclosure relates to a saw blade having the features described below.

### BACKGROUND

Saw blades are currently marketed, for example, under the designation “Bosch S 1122 VFR Special for Pallet Repair Säbelsägeblätter” (reciprocating saw blades) (cf. also in this regard FIG. 5—Saw blade according to the prior art) and are used, for example, in repairing wooden pallets, for example, Euro pallets. During this use, in particular when separating out the central planks of a wooden pallet, the lateral accessibility of which is made more difficult by the adjacent planks, the saw blade has to be bent powerfully during sawing and is thereby subjected to high bending stresses transversely relative to the clamping faces or wide sides of the saw blade. The dimensions of the hand-operated machine tool interface relative to the saw blade, in particular the common clamping chuck, in particular the tool-free common clamping chuck (SDS) for reciprocating saws and the corresponding chucking shaft of the saw blade, have remained the same over the years and can particularly at least not be modified without incompatibility with old devices, in particular widened in terms of the chucking shaft width. In this case, the chucking shaft of the saw blade arrives at its loading limits and ways have to be found to meet the increased requirements without any significant change at least to the interface.

A known starting point in order to meet the increased requirements without any significant change at least to the machine interface, in particular the clamping chuck and/or the chucking shaft, is sand-blasting the chucking shaft and/or sand-blasting the transition region to the blade portion. By sand-blasting, the surface is homogenized and refined in terms of roughness. This acts counter to breakage under cyclical loading, in particular the formation of micro-notches, and the service-life of the saw blade without any breakage of the shaft and/or breakage of the saw blade can thereby be significantly increased. However, this means an additional production step which results in costs being increased.

### SUMMARY

The disclosure relates to a saw blade having the features described below. The production costs can thereby be reduced and/or the service-life of the saw blade can be increased without the shaft and/or the saw blade breaking. The combined effect of reduced production costs and increased service-life constitutes a significant advantage of the disclosure.

Consequently, the disclosure relates to a saw blade for a hand-operated machine tool, in particular a reciprocating saw blade. The saw blade has a blade portion having a cutting edge which is orientated particularly substantially along a longitudinal axis of the blade portion and an opposite blade rear. A cutting edge is defined or formed particularly by a large number of saw teeth. Instead of the saw teeth, however, the cutting edge may in principle also be constructed in the manner of a knife blade, in particular having a straight or undulating ground portion, or may be constructed differently, so that in particular workpieces can be cut up or sawn up. The cutting edge and/or the different saw teeth which here advantageously define the cutting edge can take up a large number of different forms, profiles and/or teeth or pitch patterns which are suitable for carrying out a large number of cutting operations, including, but not limited to, cutting wood, metal, plastics material and/or other materials. The reciprocating saw blade is preferably suitable for severing wooden and metal materials, in particular for repairing pallets. The saw blade further has a chucking shaft which is provided to be received by a clamping chuck of the hand-operated machine tool. The chucking shaft has a lower edge and an opposite upper edge. The upper edge and lower edge are advantageously at least partially constructed substantially parallel with each other. The lower edge is arranged on the saw blade side of the cutting edge and opposite it the upper edge is arranged on the saw blade side of the blade rear. A transition region is constructed between the chucking shaft and the blade portion. The transition region bridges a difference in spacing between the spacing of the lower edge and upper edge of the chucking shaft and the spacing between the cutting edge and the blade rear and/or parallel with the cutting edge and/or regions of the blade portion which adjoin the blade rear and which are constructed to be substantially linear. A width difference between a width of the chucking shaft and a width of the blade portion is bridged in a manner of speaking. Consequently, the transition region in the boundary region relative to the chucking shaft is conformed to the width thereof and in the boundary region relative to the blade portion or in the boundary region relative to the cutting edge and the blade rear conformed to the width thereof.

It is proposed that a transition region lower edge have a raised portion, in particular a raised portion for relieving stresses, between the lower edge of the chucking shaft and the cutting edge of the blade portion. Advantageously, an improvement, in particular homogenization, of the stresses in the shaft region and/or transition region to the blade portion can thereby be achieved. Stress peaks and/or fatigue fracture, particularly starting from the transition region lower edge which is particularly powerfully loaded in terms of tension and bending, can be reduced. A service-life of the saw blade which is particularly loaded cyclically by the stroke movement, in particular the saw blade which is tensioned in terms of bending transversely relative to the wide sides or vertically relative to the blade plane, can be substantially increased. Tests have showed that a number of cycles in which a blade tip of a saw blade which is clamped in a hand-operated machine tool is displaced transversely relative to the blade plane can thereby be significantly increased, in particular with respect to a saw blade without the raised portion, by from 50 to 100% and/or with respect to a saw blade with a sand-blasted shaft and/or sand-blasted transition region by from 10 to 50%. Consequently, the saw blade according to the disclosure, in particular a pallet repair (reciprocating) saw blade, preferably used in the repair of pallets, has a substantially increased service-life, in particular one which even substantially exceeds that of a sand-blasted saw blade. Furthermore, in spite of the measures for reducing the stresses by means of the raised portion, a stop in particular for actuating a number of turnbuckles during the insertion of the saw blade into the hand-operated machine tool can advantageously be provided, in particular as a clamping chuck actuation stop for clamping chucks of reciprocating saws. A reliable actuation of a clamping chuck or turnbuckle for clamping the saw blade can thereby be improved. A so-called parking position of an SDS can be released or actuated by the raised portion. A longitudinal positioning of the saw blade in the turnbuckle or clamping chuck for actuating the SDS and/or for reliably clamping and locking, in particular by means of a clamping pin of the SDS in a hole of the clamping end of the saw blade, can consequently be reliably ensured. Costs for producing the saw blade can be reduced because in particular an additional production step, for example, for the sand-blasting, is dispensed with. The production time can thereby also be reduced. The raised portion can advantageously be produced by stamping so that it can already be produced during the production of the saw blade blank (without any grinding of teeth).

It is proposed that the raised portion be constructed as a raised curvature or in a convex manner or as a bulge. The raised portion rises substantially transversely relative to the longitudinal axis of the chucking shaft from the region of the transition region lower edge which is adjacent in the longitudinal axial direction of the chucking shaft. It projects beyond a notional extension line of the lower edge of the chucking shaft and therefore has a greater spacing from the longitudinal axis of the chucking shaft than the lower edge. It projects above or is raised above the region of the transition region lower edge adjoining in the longitudinal axial direction. The raised portion rises or is delimited in a manner of speaking from the regions thereof adjoining in a longitudinal axial direction of the chucking shaft transversely relative to the longitudinal axis. Portions of the transition region lower edge which are arranged nearer the longitudinal axis or nearer a notional extension line of the lower edge than the raised portion are at both sides of the raised portion in a longitudinal axial direction in a manner of speaking. The raised portion may also have a tip which is in particular rounded. A region of the transition region lower edge between the raised portion and the cutting edge has, relative to the longitudinal axis of the chucking shaft, a smaller spacing than at least one region of the raised portion relative to the longitudinal axis of the chucking shaft. In a manner of speaking, it forms a recess. The recess is advantageously constructed in a substantially basin-like manner. Advantageously, the spacing from the longitudinal axis of the shaft in the region of the boundary region between the transition region lower edge and the cutting edge or the first saw tooth from the longitudinal axis of the chucking shaft is greater than at least a spacing of a region of the raised portion, in particular a maximum spacing of the raised portion from the longitudinal axis of the chucking shaft.

It is proposed that the raised portion in the longitudinal axial direction of the saw blade or the chucking shaft be constructed so as to be free from straight portions, steps and/or sharp edges. Stress peaks can thereby be prevented. The stresses can be distributed homogeneously. It is possible to avoid breakages of the saw blade, in particular of the chucking shaft or the transition region.

It is further proposed that the transition region lower edge, in particular the contour thereof, in the longitudinal axial direction of the saw blade or the chucking shaft, be defined by a spline or a polynomial line, in particular by a spline or a polynomial line which is defined by a large number of points, at which continuity of the pitch is prevalent. At both sides of the raised portion in relation to the longitudinal axis, similar stresses are thereby applied in the transition region, which can generally reduce the maximum stress within the transition region, in particular by from 5 to 15%, preferably by approximately 10%.

It is further proposed that no raised portion be arranged at a transition region upper edge between the upper edge and the blade rear of the saw blade. The distribution of stresses in the transition region, in particular in saw blades with only one cutting edge, can thereby be improved. The saw blade can be prevented from breaking.

In principle, however, a raised portion which is constructed particularly similarly to the raised portion of the transition region lower edge, can also be arranged on the transition region upper edge, particularly if the blade rear of the saw blade also has saw teeth.

It is proposed that the raised portion not be provided to be engaged round by a turnbuckle, particularly not engaged round in a positive-locking manner. In this context, this is intended to be understood to mean that the raised portion is not provided at the side facing away from the chucking shaft to be fixed and/or blocked in particular in an axially positive-locking manner by a blocking element of a turnbuckle or the like. Therefore, the saw blade is not axially fixed in a turnbuckle and/or SDS of a hand-operated machine tool by or by means of the raised portion, in particular a saw blade which is loaded in terms of stress. The raised portion is not used to directly axially fix the saw blade to the hand-operated machine tool in order to prevent it from falling out of the turnbuckle. Laterally on the wide sides of the saw blade, however, the turnbuckle can in principle also support the transition region. The T-shaped member or the lateral raised portions of the chucking shaft of T-shaped shafts, as used in a standard manner, for example, in keyhole saw blades, accordingly do not constitute a raised portion according to the disclosure particularly because they are used for axially fixing in order to prevent falling out or fixing the saw blade which is loaded in terms of stress and are further a portion of the chucking shaft which is received and engaged over by the turnbuckle, and therefore do not constitute a portion of the transition region. Particularly non-toothed portions parallel in extension of the cutting edge or with an offset relative thereto, which are relieved in particular relative to the first saw tooth when viewed from the shaft through the tooth root or tooth notch thereof, also do not constitute a raised portion supposedly according to the disclosure.

It is further proposed that a spacing between the transition region lower edge and an opposite transition region upper edge or the longitudinal axis of the chucking shaft at the chucking shaft side of the raised portion be smaller than at the blade portion side of the raised portion (when viewed in the longitudinal axial direction of the chucking shaft). The term chucking shaft side or blade portion side is intended to be understood to mean the side of the raised portion facing the chucking shaft or the blade portion. The service-life can also thereby be increased.

It is further proposed that a spacing, in particular of a vertex of the raised portion, from a rear side of the chucking shaft in a longitudinal axial direction of the chucking shaft or the saw blade be approximately from 19 to 25 mm, in particular from 21 to 22 mm. It can thereby be ensured that a parking position of existing SDS systems is reliably actuated. A spacing, in particular of a vertex of the raised portion from the boundary region of the transition region to the cutting edge, is approximately from 5 to 10 mm, in particular from 7 to 9 mm. The distribution of stresses in the transition region can thereby be improved; it is possible to prevent saw blades from breaking.

It is further proposed that a radius of the raised portion, in particular in the region of the vertex of the raised portion or in the region of the tip of the raised portion, be approximately from 0.5 to 1.5 mm, in particular approximately 1.0 mm. In particular, the stamping out of the raised portion can also thereby be simplified.

It is further proposed that stresses of the saw blade which is loaded in terms of bending transversely relative to the blade plane be neutralized in the region of the transition region upper edge and the transition region lower edge, in particular the regions which are adjacent to the raised portion in the longitudinal axial direction of the chucking shaft.

It is proposed that a boundary point between the transition region upper edge and the blade rear and a boundary point between the transition region lower edge and the cutting edge in the longitudinal axial direction of the saw blade or chucking shaft be arranged so as to be axially offset or axially in alignment. It is thereby possible for the saw blade to be adapted to different requirements of the saw blade.

It is proposed that the transition region lower edge and transition region upper edge be constructed to be at least substantially free from symmetries with respect to each other, in particular free from a mirror symmetry relative to the longitudinal axis of the chucking shaft. The transition region and/or at least portions of the chucking shaft or blade portion can be constructed in a sand-blasted manner. The surface thereof can thereby be homogenized or refined in terms of roughness. The service-life of the saw blade can sometimes further be increased.

It is proposed that the raised portion act as an actuation means of a clamping and/or closing mechanism of a clamping chuck, in particular SDS of the hand-operated machine tool, in particular in order to actuate the parking position mechanism. The user-friendliness can thereby be further increased. In particular, a longitudinal positioning of the saw blade in the turnbuckle, in particular when the saw blade is inserted in the turnbuckle, can be improved.

It is proposed that a spacing of the transition region upper edge relative to the longitudinal axis of the chucking shaft increase, in particular exponentially, from the chucking shaft as far as the blade rear and/or a spacing of the transition region lower edge relative to the longitudinal axis of the chucking shaft increase, in particular exponentially, from a recess between the raised portion and the cutting edge as far as the blade rear.

It is proposed that the transition region lower edge have a recess between the raised portion and the cutting edge, in particular a substantially basin-like recess. The recess has in particular a spacing from the longitudinal axis of the chucking shaft which is greater than a spacing of the lower edge from the longitudinal axis and a spacing which is smaller than a spacing of the raised portion from the longitudinal axis. The recess extends in the longitudinal axial direction of the chucking shaft, advantageously over more than 50%, in particular approximately from 50 to 75% of the transition region lower edge and/or by a multiple pitch width of the saw teeth and/or over approximately from 10 to 50% of the longitudinal extent of the lower edge.

Furthermore, a hand-operated machine tool, in particular a hacksaw, preferably a reciprocating saw with an above-mentioned saw blade, is disclosed.

### BRIEF DESCRIPTION OF THE DRAWINGS

Additional advantages will be appreciated from the following description of the drawings. An embodiment of the saw blade is illustrated in the drawings. The drawings, the description and the claims contain a number of features in combination. The person skilled in the art will advantageously also consider the features individually and combine them to form advantageous additional combinations.

In the drawings:

FIG. 1 is a schematic illustration of the saw blade according to the disclosure as a side view,

FIG. 2 is a schematic illustration of a cutout of the saw blade according to the disclosure according to FIG. 1,

FIG. 3 is a schematic illustration of another cutout of the cutout according to FIG. 2 of the saw blade according to the disclosure according to FIG. 1,

FIG. 4 is a chart for comparing bending test repetitions up to breakage of the shaft with different saw blades,

FIG. 5 shows a saw blade according to the prior art, currently marketed under the designation “Bosch S 1122 VFR Special for Pallet Repair”.

### DETAILED DESCRIPTION

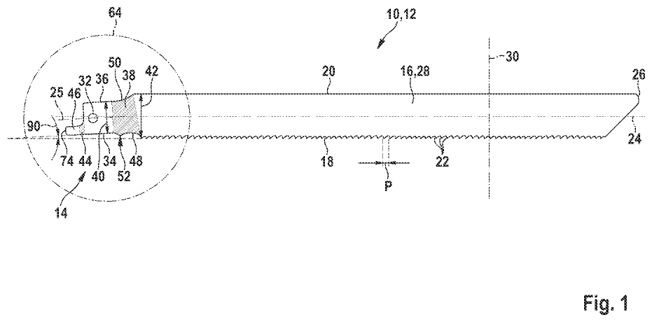

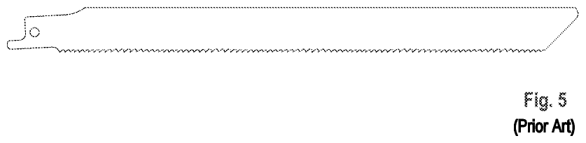

FIG. 1 shows a saw blade 10 according to the disclosure for a hand-operated machine tool (not illustrated here). The saw blade 10 is a reciprocating saw blade 12 which is provided for use with a reciprocating saw (not illustrated). The reciprocating saw blade 12 is particularly provided for repairing wooden pallets or the like. A chucking shaft 14 at least substantially corresponds to a common chucking shaft 14 for reciprocating saw blades as disclosed, for example, in the current “Bosch S 1122 VFR Special for Pallet Repair Säbelsägeblätter” (reciprocating saw blades) (cf. FIG. 5) and is further widely known. In principle, however, the form and/or the configuration of the chucking shaft 14 may vary in order to cooperate with a large number of clamping chucks. By means of the chucking shaft, the saw blade 10 can be fixed to a clamping chuck or turnbuckle (not illustrated here), in particular to an SDS of a hacksaw, in particular a reciprocating saw. The saw blade 10 has a blade portion 16 having a cutting edge 18 or front edge or working edge. The cutting edge 18 has a large number of saw teeth 22. The cutting edge 18 and/or the saw teeth 22 which define the cutting edge 18 in this case may take up a large number of different forms, profiles and/or teeth or pitch patterns which are suitable for carrying out a large number of cutting operations, including, but not limited to, cutting wood, metal, plastics material and/or other materials. The reciprocating saw blade 12 is particularly preferably suitable for severing wooden and metal materials, in particular for repairing pallets. The chucking shaft 14, a transition region 38 and the blade portion 16 are advantageously constructed or formed in one piece but may be constructed, configured or formed in a number of different, known or as yet unknown manners.

Opposite the cutting edge 18, the blade portion 16 has a blade rear 20 or a rear or a non-cutting edge. This blade rear/edge is arranged here with a defined, in particular constant, spacing from the cutting edge 18. In principle, however, the form and the configuration of the blade rear 20 may vary, for example, the blade rear 20 may also be constructed as a cutting edge, it may be constructed at an angle, in an undulating manner and/or with variable spacing from the cutting edge 18, or the like. According to FIG. 1, the cutting edge 18 and the blade rear 20 are orientated substantially along or parallel with a longitudinal axis 24 of the blade portion 16, that is to say, here in particular orientated parallel with each other. The blade portion 16 terminates at the front with a tip 26. The tip 26 can also take up a large number of known or as yet unknown forms.

In particular, the saw blade 10 is constructed in a relatively flexible manner and has to this end a relatively small blade thickness of a maximum of 1.3 mm, in particular from 0.7 to 1.1 mm, preferably approximately 0.9 mm. This thickness advantageously corresponds to the thickness of the chucking shaft 14, of the transition region 38 and of the blade portion 16. In particular, the cutting edge 18 has a cutting edge width, which is formed, for example, by setting the saw teeth 22 or the like, of a maximum of 1.7 mm, in particular from 1.1 to 1.5 mm, preferably approximately from 1.3 to 1.4 mm. Advantageously, therefore, the blade portion 16, the transition region 38 and the chucking shaft 14 are constructed with the same thickness. The saw blade 10 is therefore constructed to be relatively thin in comparison with other reciprocating saw blades for other applications so that the saw blade 10 is relatively flexible or pliable transversely to the wide sides 28 of the saw blade 10 or transversely to a blade plane (not illustrated) which is defined by the longitudinal axis 24 and a connection axle 30 which extends transversely to the longitudinal axis 24 through the cutting edge 18 and the blade rear 20.

The chucking shaft 14 is provided to be received by a clamping chuck of the hand-operated machine tool. It has a lower edge 34 and an opposite upper edge 36. The lower edge 34 is arranged on the saw blade side of the cutting edge 18 or the front side and the upper edge 36 is arranged on the saw blade side of the blade rear 20 or the rear side. The transition region 38 is constructed between the chucking shaft 14 and the blade portion 16. In this case, particularly along a longitudinal axis 25 of the chucking shaft 14 or the longitudinal axis 24 of the blade portion 16, a spacing changes between a transition region lower edge 48 and transition region upper edge 50. A spacing difference between the spacing 40 of the lower and upper edges 34, 36 of the chucking shaft 14 (cf., for example, between point H and J) and a spacing 42 between the cutting edge 18 and the blade rear 20 can thus be bridged in particular without any sharp corners, edges and/or tight radii. The transition region 38 bridges in a manner of speaking a difference in width between a width of the chucking shaft 14 and a width of the blade portion 16. The transition region 36 is in a manner of speaking adapted, on the one hand, to the width 40 of the chucking shaft 14 and, on the other hand, to the width 42 of the blade portion 16. A difference in width between the chucking shaft 14 and the blade portion 16 can thereby be bridged. The opposite lower and upper edges 34, 36 of the chucking shaft 14 are constructed substantially parallel with each other at least in portions, in particular substantially in a region between the transition region 38 and an additional transition region 44 to a cam 46 of the chucking shaft 14. They can thereby be positioned with relatively little play in the clamping chuck. In known manner, a hole 32 is arranged in the chucking shaft 14 besides the cam 46. The hole 32 acts in known manner as an auxiliary positioning means and/or clamping means for a clamping bolt or pin of the turnbuckle of the hand-operated machine tool. The cam 46 extends the lower edge 34 in known manner in order, for example, to distribute the forces which occur during sawing over a greater abutment face in the turnbuckle. In particular, the cam 46 or the upper edge 36 may also have inclined faces, chamfers or rounded portions in order, for example, to make introduction of the saw blade 10 into the turnbuckle easier. The chucking shaft 14 can also take up other known or as yet unknown configurations.

According to the disclosure, a transition region lower edge 48 has between the lower edge 34 of the chucking shaft 14 and the cutting edge 18 of the blade portion 16 a raised portion 52, in particular a stress-relieving raised portion. The raised portion is constructed in a convex manner or curved radially outwardly. It is in a manner of speaking constructed as a bulge. The raised portion 52 has in a manner of speaking a raised curvature or rounding. This projects at least when viewed in the longitudinal axial direction 25 of the chucking shaft 14 at both sides beyond a notional extension line of the lower edge 34 and/or beyond the adjoining regions of the transition region lower edge 48. The raised portion 52 rises or is delimited in a manner of speaking in the longitudinal axial direction 25 from the adjoining regions. The raised portion 52 has a particularly rounded tip. The raised portion 52 is free from in particular sharp edges, in particular in the longitudinal axial direction 24 of the saw blade 10 or longitudinal axial direction 24, 25 of the blade portion 16 or chucking shaft 14. Undesirable accumulations of stresses can thereby be avoided, in particular bending stress accumulations in the transition region 38 or boundary region between the chucking shaft 14 and blade portion 16 to the transition region 38.

The raised portion 52 is constructed to be at least substantially free from straight portions, steps and/or sharp edges in the longitudinal axial direction 24, 25 of the saw blade 10 or the chucking shaft 14. Stress peaks in the transition region 38 can also thereby be avoided. A distribution of stresses in the end portion 54 of the saw blade 10 in a saw blade 10 which is loaded in terms of lateral bending (transversely relative to the wide side 28), in particular in the central transition region 38, is substantially homogeneous and therefore of the same size, in particular also in significant portions of the transition region upper and lower edges.

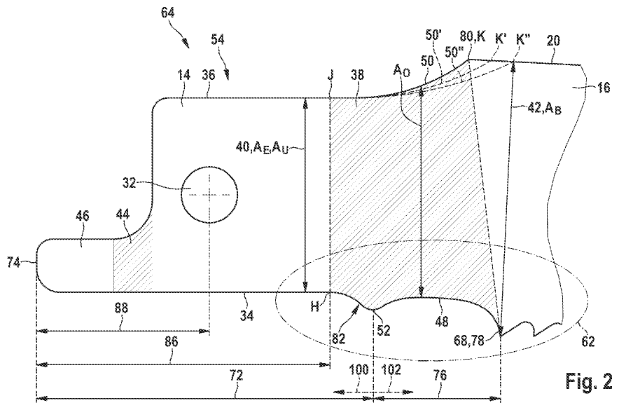

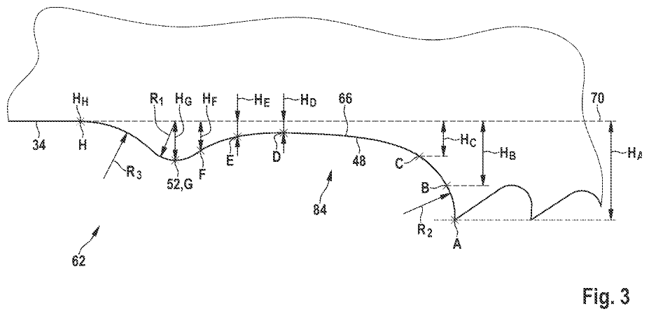

From FIG. 3, which illustrates an enlarged view of the region 62 from FIG. 2 which in turn illustrates an enlargement of the region 64 of FIG. 1, the transition region lower edge 48, in particular the contour thereof, is defined in the longitudinal axial direction 25 of the chucking shaft 14 by a spline or a polynomial line 66. A large number of points B, C, D, E, F at which continuity of the pitch is applied define this polynomial line 66. The points B and C and the points E and F are arranged with spacing relatively near each other in comparison with the points C, D and E. The transition region lower edge 48 thereby forms between the points C, D and E a basin-like recess. However, in the points F and B of the transition region lower edge 48 a relatively high pitch is provided relative to the longitudinal axis of the chucking shaft 14. In the region of the point G, the raised portion 52 forms a vertex or the tip. The raised portion 52 has a radius of curvature R1. The transition region lower edge contour 48 finally merges with a radius R3 at the point H into the lower edge of the chucking shaft 14. Conversely, it merges at the point A into the cutting edge 18 or directly here into the first or last saw tooth 68 of the cutting edge 18. A radius R2 is provided between the point A and B. The points A and B have a greater spacing H_{A}, H_{B} than the points C to H relative to the longitudinal axis 25 of the chucking shaft 14 or a notional extension line 70 of the lower edge 34 (which is constructed parallel with the longitudinal axis 25) of the chucking shaft 14. The point C has a slightly smaller spacing H_{C} relative to the longitudinal axis 25 of the chucking shaft 14 or the notional extension line 70 of the lower edge 34 than the spacing H_{G} of the point G which marks the vertex of the raised portion. The points D, E, F of the transition region lower edge 48 all have a smaller spacing H_{D}, H_{E}, H_{F} relative to the longitudinal axis 25 of the chucking shaft 14 or a notional extension line 70 of the lower edge 34 than at least the point G of the raised portion 52. The point H is arranged on the notional extension line 70 of the lower edge 34 and therefore has no spacing H_{H} therefrom or alternatively the smallest spacing from the longitudinal axis 25 of the chucking shaft 14.

At a transition region upper edge, cf. FIG. 1 or 2, however, no raised portion is arranged between the upper edge 36 and the blade rear 20 of the saw blade 10. In principle, however, a raised portion, in particular with a similar or analogue form (curved, convex) to the raised portion 52, can also be constructed in this instance on the transition region lower edge, this may be advantageous particularly if the blade rear 20 of the saw blade 10 also had saw teeth. The raised portion 52 is not provided to be engaged round by a turnbuckle, in particular not engaged round in a positive-locking manner, as known, for example, from T-shaped shafts of jigsaw blades and the associated turnbuckles thereof. A minimum spacing A_{U}, A_{O} between the transition region lower edge 48 and the opposite transition region upper edge 50 (cf. FIG. 2) is smaller at the chucking shaft side 100 of the raised portion 52 than at the blade portion side 102 of the raised portion 52. The term “chucking shaft side 100” or “blade portion side 102” is intended to be understood to mean the side facing the chucking shaft 14 or the blade portion 16 from the raised portion 52 in the longitudinal axial direction 25 of the chucking shaft 14. A spacing 72, in particular of a vertex (point G) of the raised portion 52 from a rear side 74 or end side of the chucking shaft 14 is in the longitudinal axial direction 25 of the chucking shaft 14 approximately from 19 to 25 mm, in particular from 21 to 22 mm. A spacing 76, in particular of a vertex (point g) of the raised portion 52 from the boundary point 78 (point A) of the transition region 38 to the cutting edge 18 is approximately from 5 to 10 mm, in particular from 7 to 9 mm. In total, a spacing from the rear side 74 of the chucking shaft 14 as far as the boundary point 78 (point A) is approximately from 25 to 35 mm, in particular approximately 30 mm. A spacing 88 of the hole from the rear side 74 is approximately from 11 to 11.5 mm. These dimensions may deviate depending on the configuration of the saw blade 10, in particular of the chucking shaft, transition region and blade portion.

A boundary point 80, K, K′ between the transition region upper edge 50, 50′ and the blade rear 20 and the boundary point 78, A between the transition region lower edge 48 and cutting edge 18 are arranged so as to be axially offset from each other in the longitudinal axial direction 24, 25 of the saw blade 10 or chucking shaft 14. However, they can also be arranged approximately in alignment (cf. broken line 50″ and boundary point K″). The transition region lower edge 48 and transition region upper edge 50 are constructed in the present embodiment to be at least substantially free from symmetries relative to each other, in particular free from a mirror symmetry relative to the longitudinal axis 25 of the chucking shaft 14. In principle, the transition region 38 can also be constructed to be sand-blasted or to have other means for improving the stability under loading.

Furthermore, the raised portion 52 acts as an actuation means of a clamping and/or closing mechanism of a clamping chuck (not illustrated here), in particular of an SDS of a hand-operated machine tool. The side 82 of the raised portion 52 facing the chucking shaft 14 may be used in particular as an actuation means of a parking position mechanism of an SDS.

A spacing from the longitudinal axis 25 of the chucking shaft 14 of the transition region upper edge 50 increases from the chucking shaft 14 to the blade rear 20, in particular exponentially. It increases as far as the blade rear by approximately 2.5 mm. Similarly, a spacing of the transition region lower edge 48 increases from a recess 84 between the raised portion 52 and the cutting edge 18, in particular exponentially.

The transition region lower edge 48 has the recess 84 between the raised portion 52 and the cutting edge 18. It is constructed in a substantially basin-like manner, in particular between the points C, D and E. The recess 84 has in particular a spacing from the longitudinal axis 25 of the chucking shaft 14 which is greater than a spacing of the lower edge 34 from the longitudinal axis 25 of the chucking shaft 14 and smaller than a spacing of the raised portion 52 from the longitudinal axis 25. FIG. 3 illustrates only the spacing from the extension line 70 of the lower edge 34 which extends parallel with the longitudinal axis 25, however. The recess extends in a longitudinal axial direction 25 of the chucking shaft over more than 50%, in particular approximately from 50 to 75% of the transition region lower edge 48 and/or by a multiple pitch width P of the saw teeth 22 and/or over approximately from 10 to 50% of the longitudinal extent 86 of the lower edge 34. Advantageously, the spacing H_{G} is approximately from 1 to 1.5, in particular approximately from 1.1 to 1.25 mm, the spacing H_{F} is approximately from 0.9 to 1 mm, the spacing H_{E} is approximately from 0.4 to 0.5 mm, the spacing H_{D} is approximately from 0.3 to 0.4 mm, the spacing H_{C} is approximately from 1.1 to 1.2 mm and/or the spacing H_{B} is approximately from 1.7 to 2.0 mm. A shaft angle 90 of the chucking shaft 14 relative to the longitudinal axis of the blade portion is approximately 3°. However, the spacings H_{A}-H_{G} and the shaft angle 90 may vary. For example, values from 0 to 10° are conceivable as shaft angles.

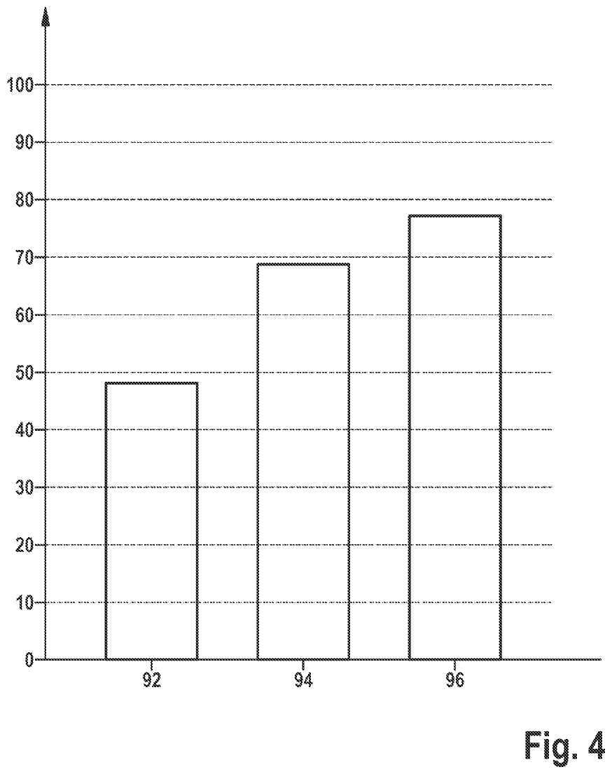

FIG. 4 illustrates the result of tests with different saw blades for repairing panels. A relative number of cycles, at which a blade tip of the saw blades which are clamped in a hand-operated machine tool has been displaced transversely relative to the blade plane until the shaft broke is indicated on the ordinate. On the left on the abscissa, the number of cycles 92 of a comparison reciprocating saw blade (as depicted in FIG. 5) without any raised portion and without any sand-blasting is indicated after the shaft broke. At the center, a number of cycles 94 of a saw blade, which is based on the comparison saw blade (as depicted in FIG. 5) and the shaft and transition region of which have been sand-blasted, is indicated after the shaft broke. On the right, the number of cycles 96 after which the shaft broke in a saw blade 10 according to the disclosure which has a raised portion 62 according to the disclosure is indicated. This explains that the saw blade 10 according to the disclosure, preferably being used for repairing pallets, has a substantially increased service-life, in particular a service-life which could even significantly exceed that of a sand-blasted saw blade according to the prior art.

1. A saw blade for a hand-operated machine tool, comprising:
a blade portion having a cutting edge and an opposite blade rear;
a chucking shaft configured to be received in a clamping chuck of the hand-operated machine tool, the chucking shaft having a lower edge and an opposite upper edge; and
a transition region formed between the chucking shaft and the blade portion, the transition region bridging a difference in spacing between a first spacing defined between the lower edge and the upper edge of the chucking shaft and a second spacing defined between the cutting edge and the blade rear, the transition region including a transition region lower edge having a raised portion between the lower edge of the chucking shaft and the cutting edge of the blade portion.

2. The saw blade according to claim 1, wherein the raised portion is formed in a convex manner or as a bulge.

3. The saw blade according to claim 1, wherein the raised portion has no straight portions, steps and/or sharp edges in a longitudinal axial direction of the saw blade or the chucking shaft.

4. The saw blade according to claim 1, wherein at least portions of the transition region lower edge are defined by a spline or a polynomial line at which continuity of the pitch is prevalent.

5. The saw blade according to claim 1, wherein the transition region includes a transition region upper edge with no upper raised portion between the upper edge and the blade rear of the saw blade.

6. The saw blade according to claim 1, wherein the raised portion is not configured to be engaged round by a turnbuckle.

7. The saw blade according to claim 1, wherein a third spacing defined between the transition region lower edge and an opposite transition region upper edge is smaller at a chucking shaft side of the raised portion than at a blade portion side of the raised portion.

8. The saw blade according to claim 1, wherein a fourth spacing from a vertex of the raised portion to a rear side of the chucking shaft is from approximately 19 to 25 mm, and/or a fifth spacing from the vertex of the raised portion to the boundary point or boundary region between the transition region and the cutting edge is from approximately 5 to 10 mm.

9. The saw blade according to claim 1, wherein a radius of the raised portion in a region of the raised portion adjoining a vertex or a tip is between approximately 0.5 and 1.5 mm.

10. The saw blade according to claim 1, wherein the saw blade is configured such that stresses of the saw blade, which is loaded in terms of bending transversely relative to a blade plane, are neutralized in the transition region in a region of the transition region upper edge and the transition region lower edge which are adjacent to the raised portion in a longitudinal axial direction of the chucking shaft.

11. The saw blade according to claim 1, wherein a first boundary point between the transition region upper edge and the blade rear and a second boundary point between the transition region lower edge and the cutting edge are arranged so as to be axially offset or axially in alignment in a longitudinal axial direction of the saw blade or chucking shaft.

12. The saw blade according to claim 1, wherein the transition region lower edge and the transition region upper edge are at least substantially free from a mirror symmetry relative to the longitudinal axis of the chucking shaft.

13. The saw blade according to claim 1, wherein the raised portion acts as an actuation structure of a clamping and/or closing mechanism of a clamping chuck so as to actuate a parking position mechanism.

14. The saw blade according to claim 1, wherein a third spacing between the transition region upper edge and a longitudinal axis of the chucking shaft increases exponentially from the chucking shaft to the blade rear and/or a fourth spacing between the transition region lower edge and the longitudinal axis increases exponentially from a recess between the raised portion and the cutting edge.

15. The saw blade according to claim 1, wherein:
the transition region lower edge defines a recess between the raised portion and the cutting edge, from which a third spacing to a longitudinal axis of the chucking shaft is greater than a fourth spacing between the lower edge and the longitudinal axis and is smaller than a fifth spacing between the raised portion and the longitudinal axis, and
the recess extends in a longitudinal axial direction over more than 50% of the transition region lower edge and/or by a multiple of a pitch width of the saw teeth and/or over from approximately 10% to 50% of a longitudinal extent of the lower edge.

16. The saw blade according to claim 1, wherein the saw blade is a reciprocating saw blade, and the cutting edge is defined by a large number of saw teeth.

17. A hand-operated tool comprising:
a saw blade, comprising:
a blade portion having a cutting edge and an opposite blade rear;
a chucking shaft configured to be received in a clamping chuck of the hand-operated machine tool, the chucking shaft having a lower edge and an opposite upper edge; and
a transition region formed between the chucking shaft and the blade portion, the transition region bridging a difference in spacing between a first spacing defined between the lower edge and the upper edge of the chucking shaft and a second spacing defined between the cutting edge and the blade rear, the transition region including a transition region lower edge having a raised portion between the lower edge of the chucking shaft and the cutting edge of the blade portion.
